(19) United States
(12) Patent Application Publication
(10) Pub. No.: US 2026/0197034 A1
(43) Pub. Date: Jul. 9, 2026

(54) WIRELESS COMMUNICATIONS OVER A POWERED REFLECTIVE ARRAY

(71) Applicant: T-MOBILE INNOVATIONS LLC, Overland Park, KS (US)

(72) Inventor: Chad Chun Fai Au, Kirkland, WA (US)

(21) Appl. No.: 19/013,911

(22) Filed: Jan. 8, 2025

(51) Int. Cl. H04B 7/04; H02J 50/00

(52) U.S. Cl. CPC H04B 7/04013; H02J 50/001

(57) ABSTRACT

A reflective array harvests electrical power from one of solar radiation and terrestrial radio signals. The reflective array determines a geographic direction using the harvested electrical power. The reflective array wirelessly receives a communication signal. The reflective array phase-shifts the communication signal for transmission toward the geographic direction. The reflective array wirelessly transmits the phase-shifted communication signal toward the geographic direction.

### TECHNICAL BACKGROUND

Wireless communication networks deliver wireless data services to wireless user devices. The wireless data services comprise internet-access, video-calling, media-streaming, machine communications, and other user applications. The wireless user devices might be phones, computers, sensors, robots, or some other user apparatus. The wireless communication networks comprise wireless access nodes, network controllers, and network routers. The wireless user devices and the wireless access nodes exchange wireless data signals to support the wireless data services. Although the wireless signals propagate through solid materials, the solid materials typically weaken the wireless data signals—possibly to a point that causes a loss of the wireless data services. Higher frequencies like millimeter waves are more susceptible to wireless data signal loss than lower frequencies.

The wireless data services are an important alternative to traditional data services that use cable or fiber “to-the-premise” networks. In densely populated areas, the wireless data services are more efficient because of the network capacity and density that is available in those densely populated areas. However, the densely populated areas include numerous obstructions to the propagation of the wireless data signals. Buildings and other structures—possibly including hilly terrain—weaken and destroy wireless signal propagation.

Wireless repeaters receive and retransmit the wireless signals between the wireless user devices and the wireless access nodes in a manner that redirects the wireless signals around the structures and hills. A wireless repeater may have directional antenna arrays that each comprise periodically spaced antenna elements. One directional antenna array may be pointed at a user area, and the other directional antenna array may be pointed at a wireless access node. The directional antenna arrays may beamform the wireless signals toward their intended target. The antenna arrays require antenna isolation between the arrays which can be difficult when the angle between targets is small.

A Van Atta Reflective Array (VARA) comprises an array of periodically-spaced antenna elements that are coupled through phase-shifters and possibly an amplifier. The VARA receives wireless data signals and reflects the signals in a selected direction. Multiple versions of the received signal are individually phase-shifted to control the direction of the reflection. For example, a VARA may receive a wireless signal from a wireless access node and reflect the wireless signal toward a wireless user device. The VARA does not require the same antenna isolation as the wireless repeater antenna arrays. Although the VARA may be a passive device that does not require electrical power, the VARA may also be an active device that consumes electrical power to amplify the received wireless signals for reflection.

Solar cells provide a power source where sunshine is available. Another power source is a Radio Frequency (RF) harvester. The RF harvester converts available electromagnetic waves into electrical energy. The available electromagnetic waves may be broadcast media signals, wireless network signals, wireless fidelity signals, public safety signals, user-to-user signals, or some other RF wave.

### TECHNICAL OVERVIEW

An exemplary method comprises the following operations. Harvest electrical power from one of solar radiation and terrestrial radio signals. Determine a geographic direction using the harvested electrical power. Wirelessly receive a communication signal. Phase-shift the communication signal for transmission toward the geographic direction. Wirelessly transmit the phase-shifted communication signal toward the geographic direction.

In some examples, a reflective array comprises radiating elements and a signal processor. The radiating elements wirelessly receive downlink signals from a network direction. The radiating elements wirelessly receive uplink signals from a user direction. The signal processor determines the user direction, and in response, phase-shifts the downlink signals for transmission in the user direction. The radiating elements wirelessly transmit the phase-shifted downlink signals in the user direction and wirelessly transmit the uplink signals in the network direction. Pairs of the radiating elements are coupled together through the signal processor and each one of the pairs exchange individual ones of the uplink signals and individual ones of the downlink signals through the signal processor.

In some examples, a Van Atta Reflective Array (VARA) comprises at least one of a solar power harvester and a Radio Frequency (RF) power harvester to generate electrical power. The VARA comprises VARA elements that wirelessly receive first signals and second signals. The VARA comprises a VARA processor to consume the electrical power and phase-shift the second signals based on the first signals. The VARA elements wirelessly transmit the first signals and the phase-shifted second signals.

### DESCRIPTION OF THE DRAWINGS

FIG. 1 illustrates an exemplary data system that uses a powered reflective array to transfer signals between a User Equipment (UE) and a wireless Access Node (AN).

FIG. 2 illustrates an exemplary operation of the data system to use the powered reflective array to transfer the signals between the UE and the wireless AN.

FIG. 3 illustrates an exemplary operation of the data system to use the powered reflective array to transfer signals between the UE and the wireless AN.

FIG. 4 illustrates an exemplary reflective array to transfer signals between wireless communication devices.

FIG. 5 illustrates an exemplary wireless communication network that uses a Van Atta Reflective Arrays (VARAs) to transfer signals between User Equipment (UE) and wireless Access Nodes (ANs).

FIG. 6 illustrates an exemplary User Equipment (UE) in the wireless communication network that uses the VARAs to transfer signals between the UE and the wireless ANs.

FIG. 7 illustrates an exemplary 5GNR AN in the wireless communication network that uses the VARA to transfer signals between the UE and the 5GNR AN.

FIG. 8 illustrates an exemplary Wireless Fidelity (WIFI) AN in the wireless communication network that uses the VARA to transfer signals between the UE and the WIFI AN.

FIG. 9 illustrates an exemplary Satellite (SAT) AN and SAT Ground Station (GND) in the wireless communication network that uses the VARA to transfer signals between the UE and the SAT AN.

FIG. 10 illustrates an exemplary Network Function Virtualization Infrastructure (NFVI) in the wireless communication network that uses the VARAs to transfer signals between the UE and the wireless ANs.

FIG. 11 illustrates an exemplary VARA in the wireless communication network that uses the VARA to transfer signals between the UE and the wireless ANs.

FIG. 12 illustrates an exemplary operation of the wireless communication network that uses a remote VARA controller to control the VARA to transfer signals between the UE and the 5GNR AN.

FIG. 13 illustrates an exemplary operation of the wireless communication network that has VARA with an internal VARA processor to control the transfer of signals between the UE and the 5GNR AN.

FIG. 14 illustrates exemplary processing circuitry for a reflective array that transfers signals between wireless communication devices.

FIG. 15 illustrates an exemplary VARA that uses a manual input to transfer signals between a user site and a wireless access AN.

### DETAILED DESCRIPTION

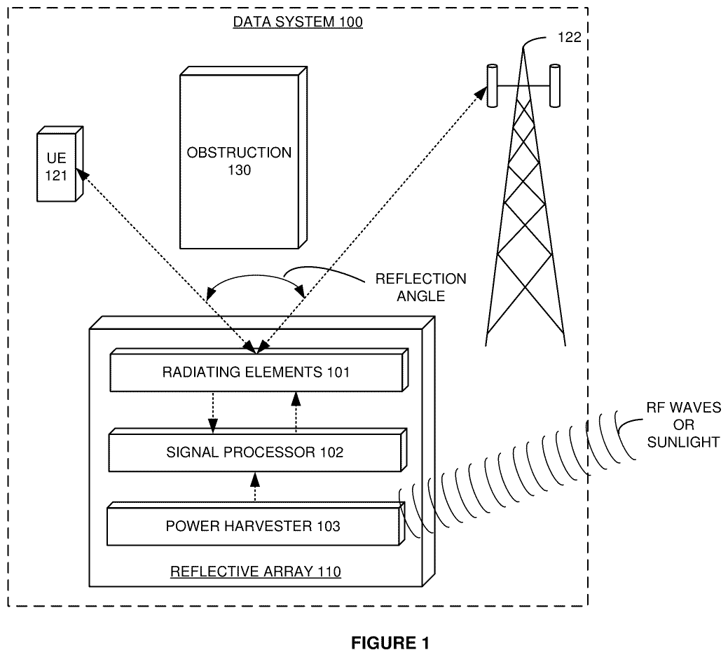

FIG. 1 illustrates exemplary data system 100 that uses reflective array 110 to transfer signals between User Equipment (UE) 121 and wireless Access Node (AN) 122. Data system 100 comprises reflective array, UE 121, and wireless AN 122. Reflective array 110 comprises radiating elements 101, signal processor 102, and power harvester 103. Obstruction 130 inhibits wireless signal propagation on a direct line between UE 121 and wireless AN 122. UE 121 and wireless AN 122 exchange wireless signals over reflective array 110. The wireless signals between radiating elements 101 and UE 121 form a reflection angle with the wireless signals between radiating elements 101 and wireless AN 122. Signal processor 102 controls this reflection angle to help optimize wireless signal propagation between UE 121 and wireless AN 122. Power harvester 103 converts Radio Frequency (RF) waves and/or sunlight into electrical power that drives signal processor 102 and possibly radiating elements 101.

UE 121 comprises a phone, computer, vehicle, and/or some other apparatus with wireless communication components. Wireless AN 122 comprises a Fifth Generation New Radio (5GNR) NodeB, Wireless Fidelity (WIFI) hotspot, earth satellite, and/or some other apparatus with wireless communication components. Radiating elements 101 comprise antennas like metallic rods, patches, and the like. Signal processor 102 comprises a microprocessor and/or some other signal processing circuitry. Power harvester 103 comprises an RF power generator, solar power generator, and/or some other power source. Alternative power sources like batteries or kinetic energy could also be used.

In some examples, power harvester 103 harvests electrical power for signal processor 102 from solar radiation and/or terrestrial RF signals. Using the harvested electrical power, signal processor 102 determines a geographic direction toward UE 121. For downlink communications from wireless AN 122 to UE 121, wireless AN 122 transmits downlink wireless signals to radiating elements 101. Radiating elements 101 receive the downlink wireless signals and transfer corresponding downlink electrical signals to signal processor 102. Signal processor 102 phase-shifts the downlink electrical signals to optimize propagation in the geographic direction toward UE 121—possibly using the harvested electrical power. Signal processor 102 typically uses the harvested electrical power to amplify the downlink wireless signals to optimize propagation in the geographic direction toward UE 121. Signal processor 102 may also use the harvested electrical power to filter the downlink wireless signals for a specific RF spectrum. Signal processor 102 transfers the phase-shifted downlink electrical signals to radiating elements 101. Radiating elements 101 wirelessly transmit corresponding downlink wireless signals toward the geographic direction of UE 121. UE 121 wirelessly receives the downlink wireless signals.

In some examples, power harvester 103 harvests electrical power for signal processor 102 from solar radiation and/or terrestrial RF signals. Using the harvested electrical power, signal processor 102 determines a geographic direction toward wireless AN 122. For uplink communications from UE 121 to wireless AN 122, UE 121 transmits uplink wireless signals to radiating elements 101. Radiating elements 101 receive the uplink wireless signals and transfer corresponding uplink electrical signals to signal processor 102. Signal processor 102 phase-shifts the uplink electrical signals to optimize propagation in the geographic direction toward wireless AN 122—possibly using the harvested electrical power. Signal processor 102 typically uses the harvested electrical power to amplify the uplink wireless signals to optimize propagation in the geographic direction toward wireless AN 122. Signal processor 102 may also use the harvested electrical power to filter the uplink wireless signals for a specific RF spectrum. Signal processor 102 transfers the phase-shifted uplink electrical signals to radiating elements 101. Radiating elements 101 wirelessly transmit corresponding uplink wireless signals toward the geographic direction of wireless AN 122. Wireless AN 122 wirelessly receives the uplink wireless signals.

In some examples, the phase-shifting could be omitted on the downlink and/or the uplink. Signal processor 102 may amplify the downlink and/or the uplink signals without phase-shifting. Signal processor 102 may filter the downlink and/or the uplink signals without phase-shifting. Signal processor 102 may determine the geographic direction toward UE 121 based on the uplink wireless signals from UE 121. For example, signal processor 102 may determine the angle-of-arrival for the uplink wireless signals and process the uplink angle-of-arrival to determine the geographic direction to UE 121. Signal processor 102 may determine the geographic direction toward wireless AN 122 based on the downlink wireless signals from wireless AN 122. For example, signal processor 102 may determine the angle-of-arrival for the downlink wireless signals and process the downlink angle-of-arrival to determine the direction to wireless AN 122.

In some examples, signal processor 102 receives control information from an external network element like wireless AN 122 that indicates the geographic direction toward UE 122 and/or the geographic direction toward wireless AN 122. The control information may also indicate power levels for amplification and bandwidths for filtering. Multi-band filtering and transmissions may be used. Thus, reflective array 110 could reflect different radio beams that use different RF channels in different geographic directions. Signal processor 102 may also receive control information from a user interface on reflective array 110. The user interface could be buttons, dials, Bluetooth, WIFI, touchscreens, and the like.

In some examples, reflective array 110 comprises a Van Atta Reflective Array (VARA). The VARA couples pairs of radiating elements 101 together through signal processor 102. Each pair of radiating elements 101 exchange individual versions of the uplink signals and individual versions the downlink signals through signal processor 102. Signal processor 102 determines and applies individual downlink phase-shifts for the pairs radiating elements 102. Signal processor 102 may also determine and apply individual uplink phase-shifts for the pairs radiating elements 102. Signal processor 102 may determine and apply individual downlink and/or uplink amplification levels for the pairs radiating elements 102. Signal processor 102 may determine and apply individual downlink and/or uplink filter bandwidths for the pairs radiating elements 102. Groups of radiating elements 102 may share filters, amplifiers, and phase shifters in some examples.

Reflective array 110, UE 121, and wireless AN 122 wirelessly communicate using wireless protocols like WIFI, 5GNR, satellite, Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and/or some other wireless protocol. Reflective array 110, UE 121, and wireless AN 122 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

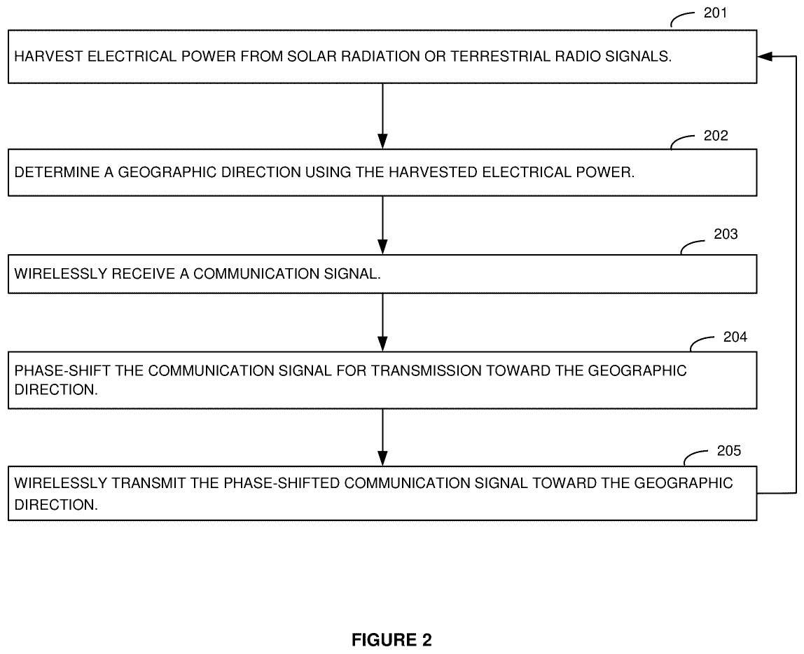

FIG. 2 illustrates an exemplary operation of data system 100 to use reflective array 110 to transfer signals between UE 121 and wireless AN 122. The operation may differ in other examples. Reflective array 110 harvests electrical power from solar radiation or terrestrial radio signals (201). Reflective array 110 determines a geographic direction using the harvested electrical power (202). Reflective array 110 wirelessly receives a communication signal (203). Reflective array 110 phase-shifts the communication signal for transmission toward the geographic direction (204). Reflective array 110 wirelessly transmits the phase-shifted communication signal toward the geographic direction (205).

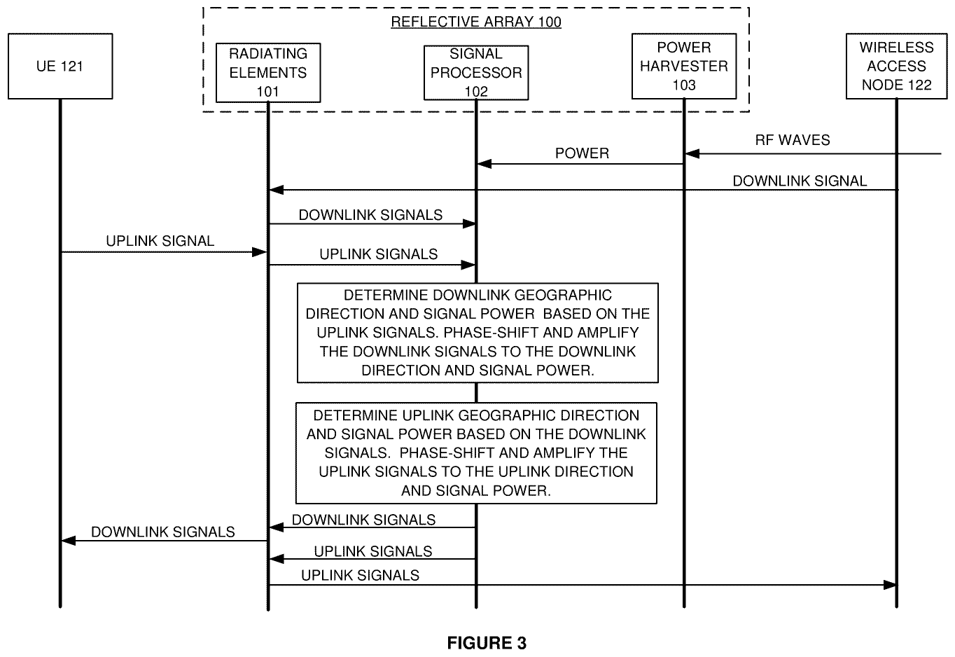

FIG. 3 illustrates an exemplary operation of data system 100 to use reflective array 110 to transfer signals between UE 121 and wireless access node 122. The operation may differ in other examples. Power harvester 103 receives RF waves that are ambient or that are generated to provide wireless power. Power harvester 103 generates electrical power from the RF waves. Power harvester 103 transfers the electrical power to signal processor 102.

Wireless AN 122 wirelessly transmits a downlink communication signal to radiating elements 101. Individual ones of radiating elements 101 wirelessly receive the downlink communication signal and transfer their versions of the downlink communication signal (downlink signals) to signal processor 102. Contemporaneously, UE 121 wirelessly transmits an uplink communication signal to radiating elements 101. Individual radiating elements 101 wirelessly receive the uplink communication signal and transfer their versions of the uplink communication signal (uplink signals) to signal processor 102.

Signal processor 102 determines a downlink geographic direction and signal power based on the angle-of-arrival and signal strength of the uplink signals. Signal processor 102 phase-shifts the downlink signals to the downlink geographic direction. Signal processor 102 amplifies the downlink signals to the downlink signal power. For example, signal processor 102 may phase-shift the downlink signals for propagation to the angle-of-arrival of the uplink signals. Signal processor 102 may amplify the downlink signals to reach UE 121 without over-amplifying the downlink signals and generating unwanted interference.

Signal processor 102 determines an uplink geographic direction and signal power based on the angle-of-arrival and signal strength of the downlink signals. Signal processor 102 phase-shifts the uplink signals to the uplink geographic direction. Signal processor 102 amplifies the uplink signals to the uplink signal power. For example, signal processor 102 may phase-shift the uplink signals for propagation to the angle-of-arrival of the downlink signals. Signal processor 102 may amplify the uplink signals to reach wireless AN 122 without over-amplifying the uplink signals and generating unwanted interference.

Signal processor 102 transfers the phase-shifted and amplified downlink signals to radiating elements 101. Radiating elements 101 wirelessly transmit the phase-shifted and amplified downlink signals to UE 121. Signal processor 102 transfers the phase-shifted and amplified uplink signals to radiating elements 101. Radiating elements 101 wirelessly transmit the phase-shifted and amplified uplink signals to wireless AN 122.

Advantageously, data system 100 uses harvested electrical power to efficiently reflect radio beams between wireless communication devices. Moreover, data system 100 effectively identifies radio targets and points the radio beams at the radio targets.

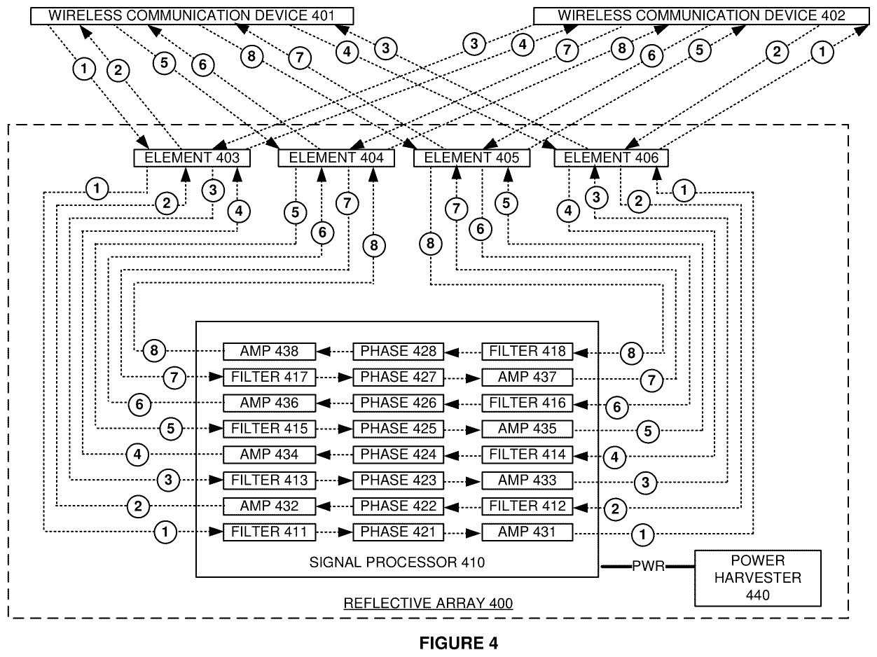

FIG. 4 illustrates an exemplary reflective array 400 to transfer signals between wireless communication devices 401-402. Reflective array 400 comprises an example of reflective array 110, although array 110 may differ. Wireless communication devices 401-402 could be phones, computers, vehicles, robots, wireless access nodes, or some other apparatus that is capable of wireless communications. Reflective array 400 comprises radiating elements 403-406, signal processor 410, and power harvester 440. Signal processor 410 comprises filters 411-418, phase-shifters (PHASE) 421-428, and amplifiers (AMP) 431-438. Power harvester 440 harvests energy from sunlight and/or RF waves and transfers the resulting electrical power to signal processor 410. Reflective array 400 may comprise a Van Atta Reflective Array (VARA).

Radiating elements 403 and 406 comprise a radiating element pair that are coupled through signal processor 410. Radiating elements 404 and 405 comprise another radiating element pair that are coupled through signal processor 410. Each one of radiating elements 403-406 wirelessly receives communication signals from wireless communication devices 401-402, and each one of radiating elements 403-406 wirelessly transmits communication signals to wireless communication devices 401-402. On FIG. 4, these eight signals are numbered one through eight.

The amount of radiating elements shown on FIG. 4 has been restricted for clarity and more elements may be added that are configured and operate in the manner of radiating elements 403-406. For example, two more pairs of radiating elements could be added and coupled through signal processor 410 to form a row of eight elements. A four-by-four grid of radiating elements (#1 at the top left and #16 at the bottom right) would be paired and coupled as follows: 1/16, 2/15, 3/14, 4/13, 5/12, 6/11, 7/10, and 8/9. Signal processor 410 individually processes uplink and downlink signals between each pair of radiating elements 403-406. Each of these signals can have its own filter bandwidth, phase-shift, and amplification—although some signals may also share parameter values. In other examples, the signals could share filters, phase shifters, and/or amplifiers.

Signal processor 410 determines transmit power levels for signals one through eight to overcome path loss without generating unnecessary interference. Signal processor 410 may be configured with or receive instructions that indicate the transmit power levels to use. Signal processor 410 may identify the transmit power level at a signal source and determine the received power level from the signal source. Signal processor 410 may then determine the path loss to the signal source based on the difference between these power levels.

Signal processor 410 determines the angle-of-arrival and received strength for signals one through eight Signal processor 410 determines the geographic direction from reflective array 400 to wireless communication device 401 based on the angle-of-arrival of signals one, four, five, and eight on radiating elements 403-406. Signal processor 410 determines the phase-shifts for signals two, three, six, and seven for signal propagation in the geographic direction of wireless communication device 401. Signal processor 410 determines the geographic direction from reflective array 400 to wireless communication device 402 based on the angle-of-arrival of signals two, three, six, and seven on radiating elements 403-406. Signal processor 410 determines the phase-shifts for signals one, four, five, and eight for signal propagation in the geographic direction of wireless communication device 402.

The first signal from wireless communication device 401 to wireless communication device 402 traverses radiating element 403, filter 411, phase-shifter 421, amp 431, and radiating element 406. Radiating element 403 wirelessly receives the first signal from wireless communication device 401 and transfers the first signal to filter 411 in signal processor 410. Filter 411 removes energy from the first signal that is outside of a designated bandwidth. Filter 411 transfers the filtered first signal to phase-shifter 421. Phase-shifter 421 phase-shifts the first signal for transmission to the geographic direction of wireless communication device 402. Phase-shifter 421 transfers the phase-shifted first signal to amplifier 431. Amplifier 431 amplifies the first signal to adequately reach wireless communication device 402 without generating too much unwanted interference beyond device 402. Amplifier 431 transfers the amplified first signal to radiating element 406. Radiating element 406 transfers the amplified first signal to the wireless communication device 402.

The second signal from wireless communication device 402 to wireless communication device 401 traverses radiating element 406, filter 412, phase-shifter 422, amp 432, and radiating element 403. Radiating element 406 wirelessly receives the second signal from the wireless communication device 402 and transfers the second signal to filter 412 in signal processor 410. Filter 412 removes energy from the second signal that is outside of a designated bandwidth. Filter 412 transfers the filtered second signal to phase-shifter 422. Phase-shifter 422 phase-shifts the second signal for transmission to the geographic direction of wireless communication device 401. Phase-shifter 422 transfers the phase-shifted second to amplifier 432. Amplifier 432 amplifies the second signal to adequately reach wireless communication device 401 without generating too much unwanted interference beyond device 401. Amplifier 432 transfers the amplified second signal to radiating element 403. Radiating element 403 transfers the amplified second signal to wireless communication device 401.

The third signal from wireless communication device 402 to wireless communication device 401 traverses radiating element 403, filter 413, phase-shifter 423, amp 433, and radiating element 406. Radiating element 403 wirelessly receives the third signal from wireless communication device 402 and transfers the third signal to filter 413 in signal processor 410. Filter 413 removes energy from the third signal that is outside of a designated bandwidth. Filter 413 transfers the filtered third signal to phase-shifter 423. Phase-shifter 423 phase-shifts the third signal for transmission to the geographic direction of wireless communication device 401. Phase-shifter 423 transfers the phase-shifted third signal to amplifier 433. Amplifier 433 amplifies the third signal to adequately reach wireless communication device 401 without generating too much unwanted interference beyond device 401. Amplifier 433 transfers the amplified third signal to radiating element 406. Radiating element 406 transfers the amplified third signal to the wireless communication device 401.

The fourth signal from wireless communication device 401 to wireless communication device 402 traverses radiating element 406, filter 414, phase-shifter 424, amp 434, and radiating element 403. Radiating element 406 wirelessly receives the fourth signal from wireless communication device 401 and transfers the fourth signal to filter 414 in signal processor 410. Filter 414 removes energy from the fourth signal that is outside of a designated bandwidth. Filter 414 transfers the filtered fourth signal to phase-shifter 424. Phase-shifter 424 phase-shifts the fourth signal for transmission to the geographic direction of wireless communication device 402. Phase-shifter 424 transfers the phase-shifted fourth signal to amplifier 434. Amplifier 434 amplifies the fourth signal to adequately reach wireless communication device 402 without generating too much unwanted interference beyond device 402. Amplifier 434 transfers the amplified fourth signal to radiating element 403. Radiating element 403 transfers the amplified fourth signal to wireless communication device 402.

The fifth signal from wireless communication device 401 to wireless communication device 402 traverses radiating element 404, filter 415, phase-shifter 425, amp 435, and radiating element 405. Radiating element 404 wirelessly receives the fifth signal from wireless communication device 401 and transfers the fifth signal to filter 415 in signal processor 410. Filter 415 removes energy from the fifth signal that is outside of a designated bandwidth. Filter 415 transfers the filtered fifth signal to phase-shifter 425. Phase-shifter 425 phase-shifts the fifth signal for transmission to the geographic direction of wireless communication device 402. Phase-shifter 425 transfers the phase-shifted fifth signal to amplifier 435. Amplifier 435 amplifies the fifth signal to adequately reach wireless communication device 402 without generating too much unwanted interference beyond device 402. Amplifier 435 transfers the amplified fifth signal to radiating element 405. Radiating element 405 transfers the amplified fifth signal to the wireless communication device 402.

The sixth signal from wireless communication device 402 to wireless communication device 401 traverses radiating element 405, filter 416, phase-shifter 426, amp 436, and radiating element 404. Radiating element 405 wirelessly receives the sixth signal from wireless communication device 402 and transfers the sixth signal to filter 416 in signal processor 410. Filter 416 removes energy from the sixth signal that is outside of a designated bandwidth. Filter 416 transfers the filtered sixth signal to phase-shifter 426. Phase-shifter 426 phase-shifts the sixth signal for transmission to the geographic direction of wireless communication device 401. Phase-shifter 426 transfers the phase-shifted sixth signal to amplifier 436. Amplifier 436 amplifies the sixth signal to adequately reach wireless communication device 401 without generating too much unwanted interference beyond device 401. Amplifier 436 transfers the amplified sixth signal to radiating element 404. Radiating element 403 transfers the amplified sixth signal to wireless communication device 401.

The seventh signal from wireless communication device 402 to wireless communication device 401 traverses radiating element 404, filter 417, phase-shifter 427, amp 437, and radiating element 405. Radiating element 404 wirelessly receives the seventh signal from wireless communication device 402 and transfers the seventh signal to filter 417 in signal processor 410. Filter 417 removes energy from the seventh signal that is outside of a designated bandwidth. Filter 417 transfers the filtered seventh signal to phase-shifter 427. Phase-shifter 427 phase-shifts the seventh signal for transmission to the geographic direction of wireless communication device 401. Phase-shifter 427 transfers the phase-shifted seventh signal to amplifier 437. Amplifier 437 amplifies the seventh signal to adequately reach wireless communication device 401 without generating too much unwanted interference beyond device 401. Amplifier 437 transfers the amplified seventh signal to radiating element 405. Radiating element 405 transfers the amplified seventh signal to the wireless communication device 401.

The eighth signal from wireless communication device 401 to wireless communication device 402 traverses radiating element 405, filter 418, phase-shifter 428, amp 438, and radiating element 404. Radiating element 405 wirelessly receives the eighth signal from wireless communication device 401 and transfers the eighth signal to filter 418 in signal processor 410. Filter 418 removes energy from the eighth signal that is outside of a designated bandwidth. Filter 418 transfers the filtered eighth signal to phase-shifter 428. Phase-shifter 428 phase-shifts the eighth signal for transmission to the geographic direction of wireless communication device 402. Phase-shifter 428 transfers the phase-shifted eighth signal to amplifier 438. Amplifier 438 amplifies the eighth signal to adequately reach wireless communication device 402 without generating too much unwanted interference beyond device 402. Amplifier 438 transfers the amplified eighth signal to radiating element 404. Radiating element 404 transfers the amplified eighth signal to wireless communication device 402.

Advantageously, reflective array 400 uses harvested electrical power to efficiently reflect radio beams between wireless communication devices. Moreover, reflective array 400 effectively identifies radio targets and points the radio beams at the radio targets.

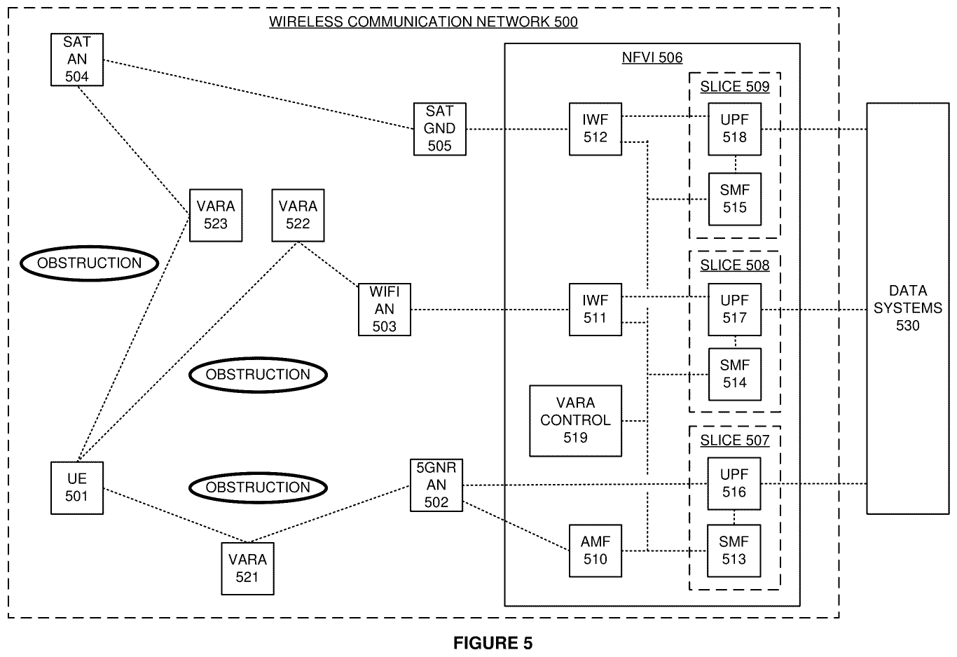

FIG. 5 illustrates exemplary wireless communication network 500 that uses Van Atta Reflective Arrays (VARAs) 521-523 to transfer signals between User Equipment (UE) 501 and wireless Access Nodes (ANs) 502-504. Wireless communication network 500 comprises an example of data system 100, although system 100 may differ. Wireless communication network 500 comprises User Equipment (UE) 501, Fifth Generation New Radio (5GNR) AN 502, Wireless Fidelity (WIFI) AN 503, earth satellite (SAT) AN 504, satellite ground station (SAT GND) 505, Network Function Virtualization Infrastructure (NFVI) 506, and VARAs 521-523. NFVI 506 comprises wireless network slices 507-509, Access and Mobility Management Function (AMF) 510, Interworking Functions (IWFs) 511-512, and VARA control system 519. Wireless network slice 507 comprises Session Management Function (SMF) 513 and User Plane Function (UPF) 516. Wireless network slice 508 comprises SMF 514 and UPF 517. Wireless network slice 509 comprises SMF 515 and UPF 518. VARAs 521-523 comprise radiating elements, signal processors, and power sources like solar cells, RF harvesters, batteries, and/or electrical plugs for power outlets. For clarity, only a single UE 501 is shown on FIG. 5, but additional UEs would typically be located near UE 501 and operate in a similar manner.

In a first example, UE 501 and 5GNR AN 502 communicate over VARA 521 to avoid the intervening obstruction. UE 501 registers with AMF 510 over VARA 521 and 5GNR AN 502. AMF 510 and SMF 513 develop UE context like network addresses and data rates for UE 501. SMF 513 transfers the UE context to UPF 516. AMF 510 transfers the UE context to 5GNR AN 502. AMF 510 transfers the UE context to UE 501 over 5GNR AN 502 and VARA 521. Based on the UE context, UE 501 communicates with data systems 530 over VARA 521, 5GNR AN 502, and UPF 516. VARA 521 reflects downlink signals from 5GNR AN 502 to UE 501 and reflects uplink signals from UE 501 to 5GNR AN 502.

Over AMF 510 and 5GNR AN 502, VARA controller 519 may direct VARA 521 to use filter bandwidths—and single band or multi-band filtering is possible. Alternatively, VARA 521 may determine the filter bandwidths by scanning the frequencies used by UE 501 and 5GNR AN 502. VARA 521 may transmit signal information to VARA controller 519 over 5GNR AN 502 and AMF 510, and VARA controller 519 may return these filter bandwidths.

VARA 521 determines the geographic direction to UE 501 based on signals from UE 501—possibly by determining angle-of arrival. VARA 521 determines the geographic direction to 5GNR AN 502 based on signals from 5GNR AN 502—possibly by determining angle-of arrival. VARA 521 may transmit signal information to VARA controller 519 over 5GNR AN 521 and AMF 510, and VARA controller 519 may return these geographic directions.

Over AMF 510 and 5GNR 521, VARA controller 519 may direct VARA 521 to use downlink amplification levels for UE 501 and uplink amplification levels for 5GNR AN 502. The amplification levels should provide adequate signal strength at the receiver without generating unnecessary interference. Alternatively, VARA 521 may determine the amplification levels by comparing received signal strength to transmit signal strength to overcome path loss. Individual amplification levels may be determined for individual uplink and/or downlink signals to beamform these signals in the proper geographic direction. VARA 521 may transmit signal information to VARA controller 519 over 5GNR AN 521 and AMF 510, and VARA controller 519 may return these individual amplification levels. VARA 521 may track and point to a moving object like a smartphone version of UE 501 or a mobile version of 5GNR AN 502.

In a second example, UE 501 and WIFI AN 503 communicate over VARA 522 to avoid the intervening obstruction. UE 501 registers with AMF 510 over VARA 522, WIFI AN 503, and IWF 511. AMF 510 and SMF 514 develop UE context like network addresses and data rates for UE 501. SMF 514 transfers the UE context to UPF 517. AMF 510 transfers the UE context to IWF 511. AMF 510 transfers the UE context to UE 501 over IWF 511, WIFI AN 503, and VARA 522. Based on the UE context, UE 501 communicates with data systems 530 over VARA 522, WIFI AN 503, IWF 511, and UPF 517. VARA 522 reflects downlink signals from WIFI AN 503 to UE 501 and reflects uplink signals from UE 501 to WIFI AN 503.

Over AMF 510, IWF 511, and WIFI AN 503, VARA controller 519 may direct VARA 522 to use filter bandwidths—and single band or multi-band filtering is possible. Alternatively, VARA 522 may determine the filter bandwidths by scanning the frequencies used by UE 501 and WIFI AN 503. VARA 522 may transmit signal information to VARA controller 519 over WIFI AN 503, IWF 511, and AMF 510, and VARA controller 519 may return these filter bandwidths.

VARA 522 determines the geographic direction to UE 501 based on signals from UE 501—possibly by determining angle-of arrival. VARA 522 determines the geographic direction to WIFI AN 503 based on signals from WIFI AN 503—possibly by determining angle-of arrival. VARA 522 may transmit signal information to VARA controller 519 over WIFI AN 503, IWF 511, and AMF 510, and VARA controller 519 may return these geographic directions.

Over AMF 510, IWF 511, and WIFI AN 503, VARA controller 519 may direct VARA 522 to use downlink amplification levels for UE 501 and uplink amplification levels for WIFI AN 503. The amplification levels should provide adequate signal strength at the receiver without generating unnecessary interference. Alternatively, VARA 522 may determine the amplification levels by comparing received signal strength to transmit signal strength to overcome path loss. Individual amplification levels may be determined for individual uplink and/or downlink signals to beamform these signals in the proper geographic direction. VARA 522 may transmit signal information to VARA controller 519 over WIFI AN 503, IWF 511, and AMF 510, and VARA controller 519 may return these individual amplification levels. VARA 521 may track and point to a moving object like a user robot or a mobile WIFI hotspot.

In a third example, UE 501 and SAT AN 504 communicate over VARA 523 to avoid the intervening obstruction. UE 501 registers with AMF 510 over VARA 523, SAT AN 504, SAT GND 505, and IWF 512. AMF 510 and SMF 515 develop UE context like network addresses and data rates for UE 501. SMF 515 transfers the UE context to UPF 518. AMF 510 transfers the UE context to IWF 512 and possibly to SAT GND 505 and/or SAT AN 504. AMF 510 transfers the UE context to UE 501 over IWF 512, SAT GND 505, SAT AN 504, and VARA 523. Based on the UE context, UE 501 communicates with data systems 530 over VARA 523, SAT AN 504, SAT GND 505, IWF 512, and UPF 518. VARA 523 reflects downlink signals from SAT AN 504 to UE 501 and reflects uplink signals from UE 501 to SAT AN 504.

Over AMF 510, IWF 512, SAT GND 505, and SAT AN 504, VARA controller 519 may direct VARA 523 to use filter bandwidths—and single band or multi-band filtering is possible. Alternatively, VARA 523 may determine the filter bandwidths by scanning the frequencies used by UE 501 and SAT AN 504. VARA 523 may transmit signal information to VARA controller 519 over SAT AN 504, SAT GND 505, IWF 512, and AMF 510, and VARA controller 519 may return these filter bandwidths. VARA 523 determines the geographic direction to UE 501 based on signals from UE 501—possibly by determining angle-of arrival.

VARA 523 determines the geographic direction to SAT AN 504 based on signals from SAT AN 504—possibly by determining angle-of arrival. VARA 523 may transmit signal information to VARA controller 519 over SAT AN 504, SAT GND 505, IWF 512, and AMF 510, and VARA controller 519 may return these geographic directions.

Over AMF 510, IWF 512, SAT GND 505, and SAT AN 504, VARA controller 519 directs VARA 523 to use downlink amplification levels for UE 501 and uplink amplification levels for SAT AN 504. The amplification levels should provide adequate signal strength at the receiver without generating unnecessary interference. Alternatively, VARA 523 may determine the amplification levels by comparing received signal strength to transmit signal strength to overcome path loss. Individual amplification levels may be determined for individual uplink and/or downlink signals to beamform these signals in the proper geographic direction. VARA 523 may transmit signal information to VARA controller 519 over SAT AN 504, SAT GND 505, IWF 512, and AMF 510, and VARA controller 519 may return these individual amplification levels. VARA 521 may track and point to a moving object like a drone version of UE 501 or orbiting SAT AN 504.

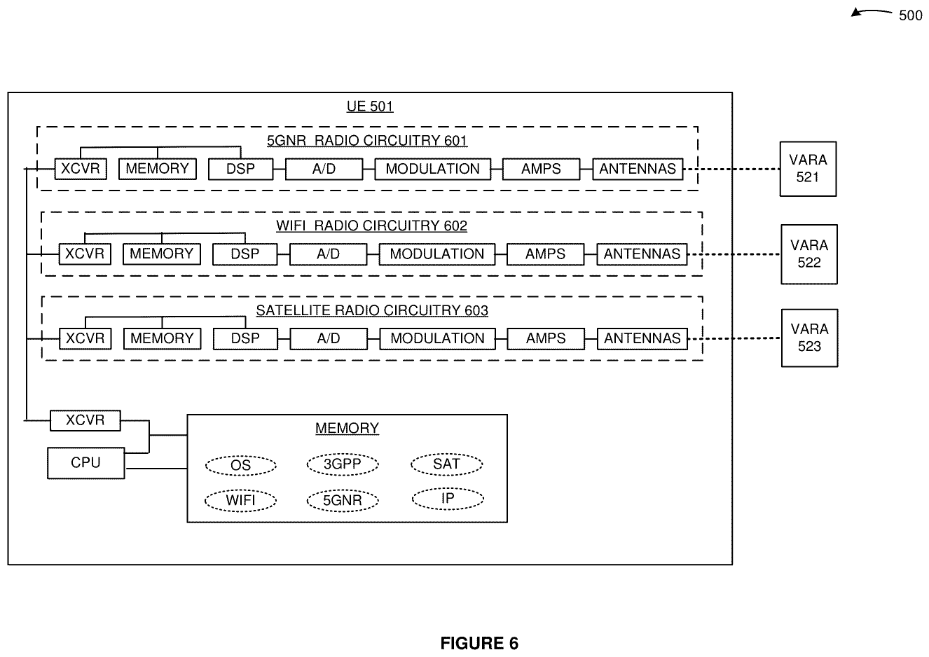

FIG. 6 illustrates exemplary UE 501 in wireless communication network 500 that uses VARAs 502-504 to transfer signals between UE 501 and wireless ANs 502-504. UE 501 comprises an example of UE 121, although UE 121 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), and Internet Protocol Application (IP). The antennas in radio circuitry 601-603 exchange wireless signals with VARAs 521-523. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

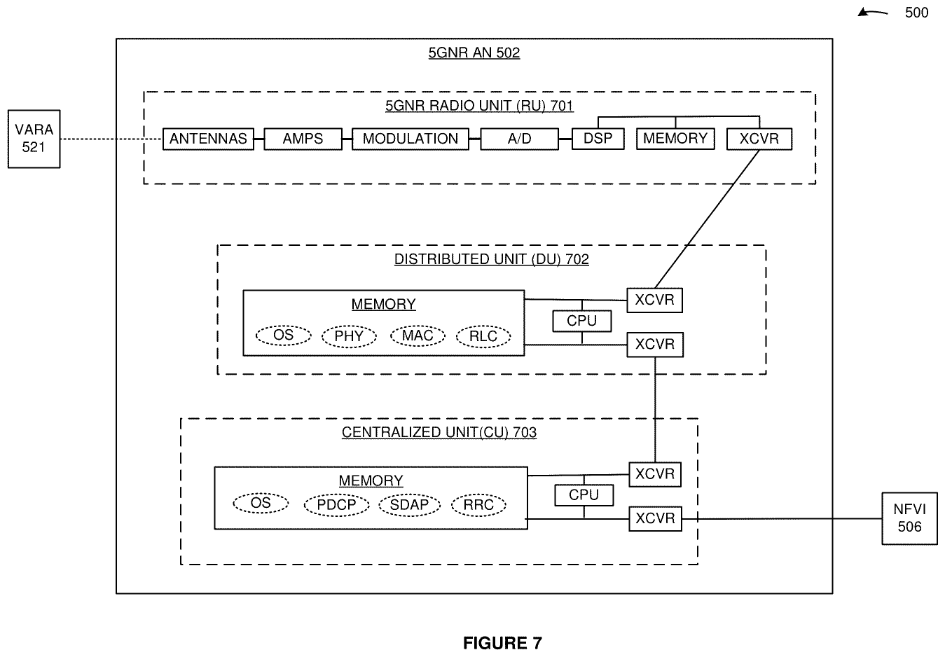

FIG. 7 illustrates an exemplary 5GNR AN 502 in wireless communication network 500 that uses VARA 521 to transfer signals between UE 501 and 5GNR AN 502. 5GNR AN 502 comprises an example of wireless access node 122, although node 122 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, transceivers, and power supply that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to VARA 521 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between VARA 521 and NFVI 506 as described herein.

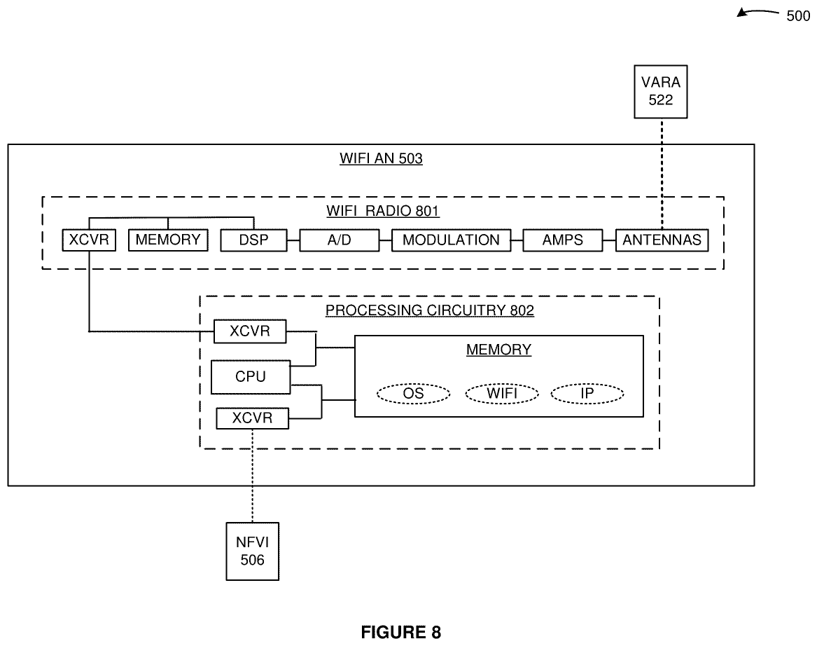

FIG. 8 illustrates exemplary Wireless Fidelity (WIFI) AN 503 in wireless communication network 500 that uses VARA 522 to transfer signals between UE 501 and WIFI AN 503. WIFI AN 503 comprises an example of wireless access node 122, although node 122 may differ. WIFI AN 503 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with VARA 522. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between VARA 522 and NFVI 506 as described herein.

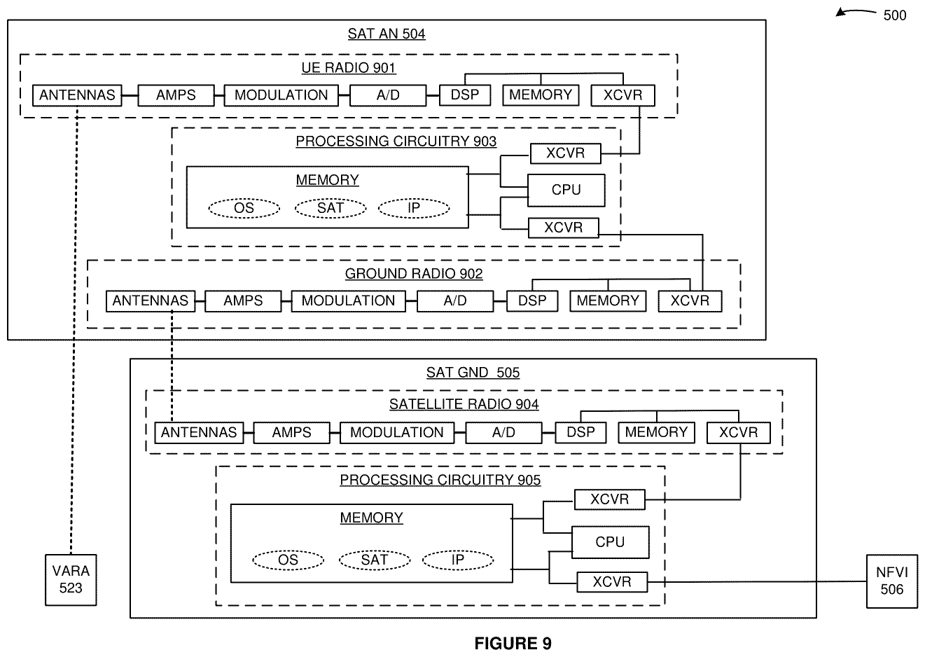

FIG. 9 illustrates exemplary Satellite (SAT) AN 504 and SAT Ground Station (GND) 505 in wireless communication network 500 that uses the VARA 523 to transfer signals between UE 502 and SAT AN 504. SAT AN 504 and SAT GND 505 comprise an example of wireless access node 122, although node 122 may differ. SAT AN 504 comprises UE radio 901, ground radio 902 and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with VARA 523. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between VARA 523 and NFVI 506 as described herein.

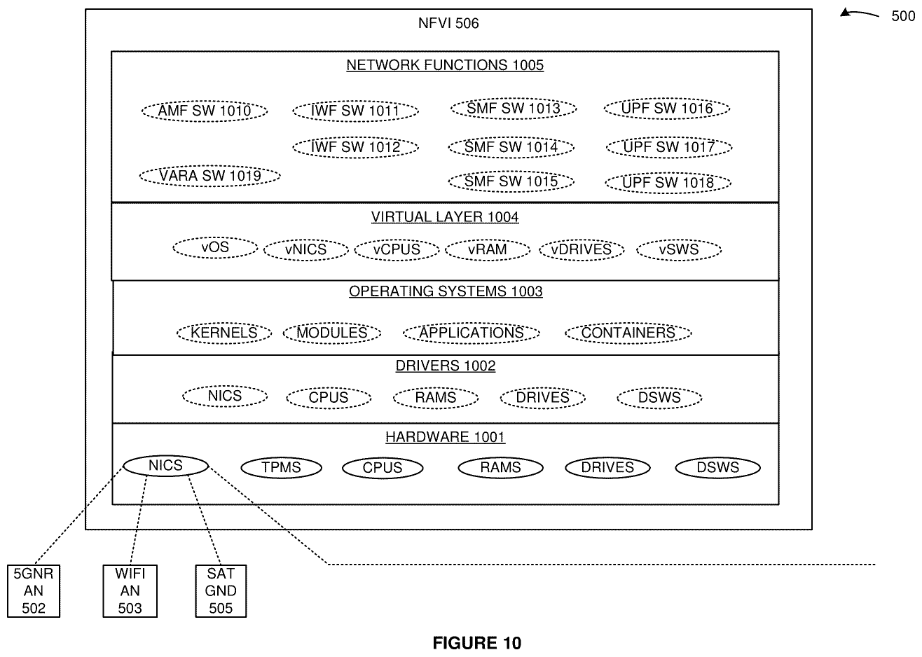

FIG. 10 illustrates exemplary Network Function Virtualization Infrastructure (NFVI) 506 in wireless communication network 500 that uses VARAs 521-523 to transfer signals between UE 501 and the wireless ANs 502-504. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF Software (SW) 1010, IWF SW 1011-1012, SMF SW 1013-1015, UPF SW 1016-1018, and VARA SW 1019. The NICS in hardware 1001 are coupled to ANs 502-503, SAT GND 505, and external systems. Hardware 1001 executes hardware drivers 1002, operating systems 1003, virtual layer 1004, and network functions 1005 to form and operate AMF 510, IWFs 511-512, SMFs 513-515, UPFs 516-518, and VARA control system 519 as described herein. NFVI 506 may be located at a single site or be distributed across multiple geographic areas. In some examples, VARA software 1019 determines filter bandwidths, amplification levels, beamforming parameters, and/or geographic directions for VARAs 521-523. For example, VARA SW 1019 may instruct VARA 521 how to beamform downlink signals to UE 501 using the proper filter bandwidths, phase-shifts, and transmit power levels.

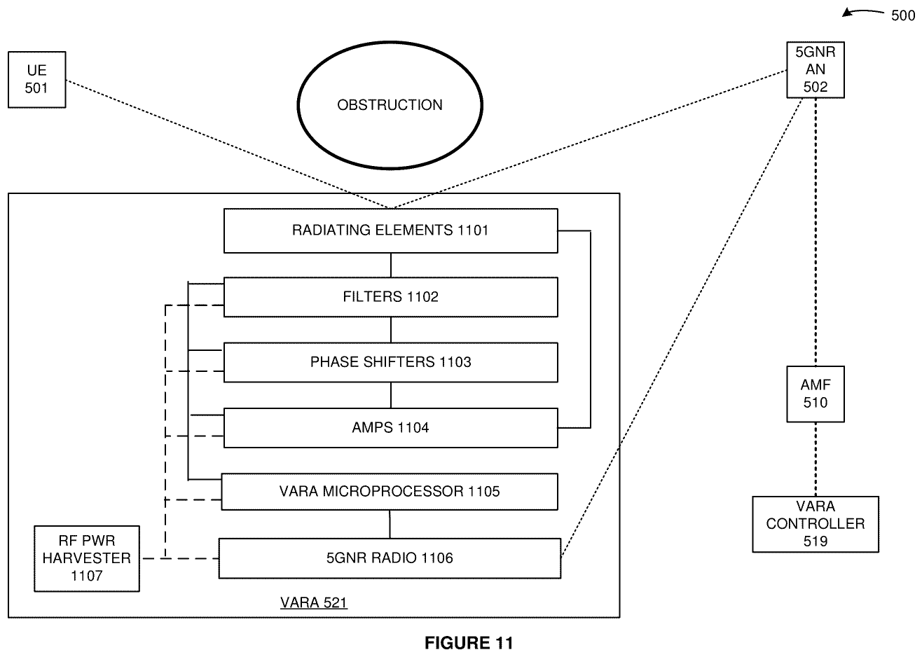

FIG. 11 illustrates exemplary VARA 521 in wireless communication network 500 that transfers signals between UE 501 and 5GNR AN 502. VARA 521 comprises an example of reflective arrays 110 and 400 and VARAs 522-523, although arrays 110 and 400 and VARAs 522-523 may differ. VARA 521 comprises radiating elements 1101, filters 1102, phase shifters 1103, amps 1104, VARA microprocessor 1105, 5GNR radio 1106, and RF power harvester 1107. RF power harvester 1107 is coupled to filters 1102, phase shifters 1103, amps 1104, VARA microprocessor 1105, and 5GNR radio 1106. VARA microprocessor 1105 is coupled to filters 1102, phase shifters 1103, amps 1104, and 5GNR radio 1106. Radiating elements 1101 are coupled to filters 1102 and amps 1104. Filters 1102 are coupled to phase shifters 1103, and phase shifters are coupled to amps 1104.

Radiating elements 1101 comprise metallic antennas like rods, patches, and the like. Filters 1102 remove energy from the signals that is outside of the designated bandwidths. Phase-shifters 1103 delay signals relative to the other signals to modify their phase. In alternative examples, filters 1102 and/or phase-shifters 1103 could be unpowered or omitted. When unpowered, filters 1102 and/or phase-shifters 1103 could be pre-configured or manually configured with their bandwidths and phase-shifts. Amps 1104 add energy to the signals and may amplify all of the signals to with the same amount of energy. 5GNR radio 506 wirelessly communicates between VARA microprocessor 1105 and 5GNR AN 502. 5GNR radio 506 could be similar to 5GNR radio circuitry 601 in UE 501 and could be omitted in alternative examples. RF power harvester 1107 converts RF waves into electrical power for filters 1102, phase shifters 1103, amps 1104, VARA microprocessor 1105, and 5GNR radio 1106. In alternative examples, filters 1102 and/or phase shifters 1103 may be unpowered.

VARA 1100 generates signal information for the signals received into radiating elements 1101. For example, a splitter could be used to send small portions of the signals to analog ports on VARA microprocessor 1105 for digital conversion and processing. Filters 1102 could split and digitize small portions of the signals and send the resulting digital signal to VARA microprocessor 1105. VARA microprocessor 1105 processes this type of signal input to generate signal information for each uplink and downlink signal between each pair of radiating elements 1101. The signal information characterizes received signal strength in the time domain.

In some examples, VARA microprocessor 1105 transfers the signal information to VARA controller 519 over 5GNR radio 1106, 5GNR AN 502, and AMF 510. VARA microprocessor 1105 then receives instructions from VARA controller 519 for the individual uplink and downlink signals between pairs of radiating elements 1101. The instructions may control the filter bandwidths, phase-shifts, and/or amplification levels for these individual signals. VARA microprocessor 1105 controls filters 1102, phase-shifters 1103, and/or amps 1104 based on the instructions. In other examples, VARA microprocessor 1105 processes the signal information to determine the filter bandwidths, phase-shifts, and/or amplification levels for these individual signals. VARA microprocessor 1105 controls filters 1102, phase-shifters 1103, and/or amps 1104 based on the determinations. In yet ither examples, VARA microprocessor 1105 could be omitted and VARA 521 could be preconfigured or manually configured with filter bandwidths, phase-shifts, and/or amplification levels.

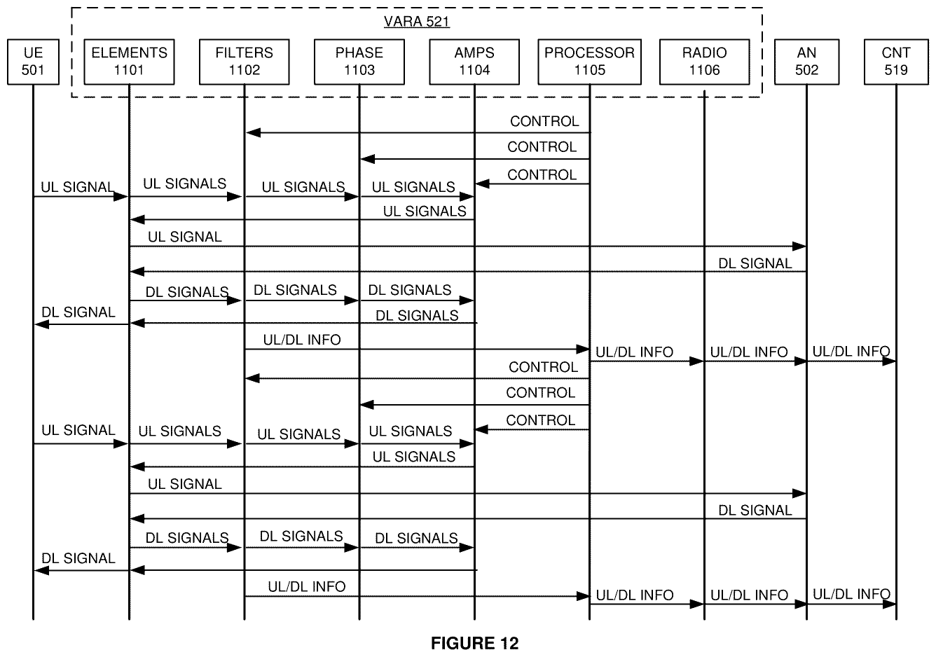

FIG. 12 illustrates an exemplary operation of wireless communication network 500 that has VARA 521 with internal VARA processor 1105 to control the transfer of signals between UE 501 and 5GNR AN 502. The operation may differ in other examples. In VARA 521, signal processor 1105 transfers filter control information to filters 1102. For example, the filter control information may indicate a channel bandwidth to pass through the filters. Signal processor 1105 transfers phase control information to phase-shifters 1103. For example, the phase control information may indicate individual time-delays for individual signals to point the downlink radio beam at UE 501 and point the uplink radio beam at 5GNR AN 502. Signal processor 1105 transfers amp control information to amps 1103. For example, the amp control information may indicate individual amplitudes for individual signals to point the downlink radio beam at UE 501 and to point the uplink radio beam at 5GNR AN 502. To determine the filter control information, signal processor 1105 may process frequency scan results to characterize the frequency channel used by 5GNR AN 502. To determine the phase control information, signal processor 1105 may process angle-of-arrival data to determine the uplink direction and the downlink direction and then determine the phase-shifts for each direction. To determine the phase control information, signal processor 1105 may process received signal strength and known transmit power to select power levels that overcome path loss without generating undue interference. The phase control information may also help steer the radio beams to the proper direction.

UE 501 wirelessly transfers an Uplink (UL) signal to radiating elements 1101. Radiating elements 1101 convert the wireless UL signal into an electrical/optical UL signals and transfer the UL signals to filters 1102. Filters 1102 split and digitize portions of the UL signals for signal processor 1105. Filters 1102 remove unwanted energy from the UL signals per the filter control information and transfer the filtered UL signals to phase shifters 1103. Phase-shifters 1103 delay the UL signals per the phase control information and transfer the phase-shifted UL signals to amps 1103. Amps 1103 add power to the UL signals per the amp control information and transfer the amplified UL signals to radiating elements 1101. Radiating elements 1101 convert the electrical/optical UL signals into a wireless uplink signal for 5GNR AN 502.

Contemporaneously with the uplink signal processing, 5GNR AN 502 wirelessly transfers a Downlink (DL) signal to radiating elements 1101. Radiating elements 1101 convert the wireless DL signal into electrical/optical DL signals and transfer the DL signals to filters 1102. Filters 1102 split and digitize portions of the DL signals for signal processor 1105. Filters 1102 remove unwanted energy from the DL signals per the filter control information and transfer the filtered DL signals to phase shifters 1103. Phase-shifters 1103 delay the DL signals per the phase control information and transfer the phase-shifted DL signals to amps 1103. Amps 1103 add power to the DL signals per the amp control information and transfer the amplified DL signals to radiating elements 1101. Radiating elements 1101 convert the electrical/optical DL signals into a wireless DL signal for 5GNR AN 502.

Contemporaneously with the UL/DL signal processing, filters 1102 transfer the digital signal information to signal processor 1105. Signal processor 1105 reports some of the signal processing information or a subsequent processing result to VARA controller (CNT) 519 over radio 1106, 5GNR AN 502, and AMF 510 (not shown on FIG. 12).

Signal processor 1105 processes the UL/DL signal information to generate and transfer the filter control information to filters 1102 (if needed). Signal processor 1105 processes the UL/DL signal information to generate and transfer phase control information to phase-shifters 1103. For example, UE 501 may be mobile and the downlink phase-shifts may change based on changes to the uplink angle-of-arrival. Signal processor 1105 generates and transfers amp control information to amps 1103 to boost and steer the UL/DL signals.

UE 501 wirelessly transfers an UL signal to radiating elements 1101. Radiating elements 1101 convert the wireless UL signal into an electrical/optical UL signals and transfer the UL signals to filters 1102. Filters 1102 split and digitize portions of the UL signals for signal processor 1105. Filters 1102 remove unwanted energy from the UL signals per the filter control information and transfer the filtered UL signals to phase shifters 1103. Phase-shifters 1103 delay the UL signals per the phase control information and transfer the phase-shifted UL signals to amps 1103. Amps 1103 add power to the UL signals per the amp control information and transfer the amplified UL signals to radiating elements 1101. Radiating elements 1101 convert the electrical/optical UL signals into a wireless uplink signal for 5GNR AN 502.

Contemporaneously with the UL signal processing, 5GNR AN 502 wirelessly transfers a DL signal to radiating elements 1101. Radiating elements 1101 convert the wireless DL signal into electrical/optical DL signals and transfer the DL signals to filters 1102. Filters 1102 split and digitize portions of the DL signals for signal processor 1105. Filters 1102 remove unwanted energy from the DL signals per the filter control information and transfer the filtered DL signals to phase shifters 1103. Phase-shifters 1103 delay the DL signals per the phase control information and transfer the phase-shifted DL signals to amps 1103. Amps 1103 add power to the DL signals per the amp control information and transfer the amplified DL signals to radiating elements 1101. Radiating elements 1101 convert the electrical/optical DL signals into a wireless DL signal for 5GNR AN 502.

Contemporaneously with the UL/DL signal processing, filters 1102 transfer the digital signal information to signal processor 1105. Signal processor 1105 reports some of the signal processing information or a subsequent processing result to VARA controller 519 over radio 1106, 5GNR AN 502, and AMF 510.

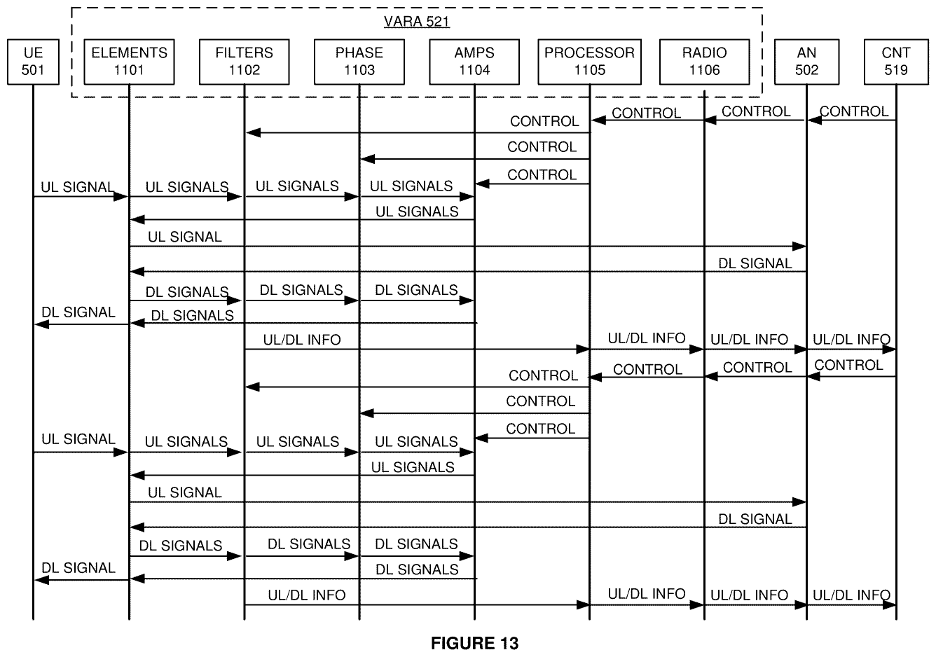

FIG. 13 illustrates an exemplary operation of wireless communication network 500 to use VARA controller (CNT) 519 to remotely control VARA 521 to transfer signals between the UE 502 and 5GNR AN 502. The operation may differ in other examples. VARA controller 519 generates and transfers filter control information to signal processor 1105 over AMF 510 (not shown on FIGS. 13), 5GNR AN 502, and radio 1106. Signal processor 1105 transfers filter instructions based on the filter control information to filters 1102. The filter control information may indicate a channel bandwidth. VARA controller 519 generates and transfers phase control information to signal processor 1105. Signal processor 1105 transfers phase instructions based on the phase control information to phase-shifters 1103. The phase control information may point radio beams in their target directions. VARA controller 519 generates and transfers amp control information to signal processor 1105. Signal processor 1105 transfers amp instructions based on the amp control information to amps 1104. The amp control information may overcome path loss and point radio beams.

UE 501 wirelessly transfers an Uplink (UL) signal to radiating elements 1101. Radiating elements 1101 convert the wireless UL signal into an electrical/optical UL signals and transfer the UL signals to filters 1102. Filters 1102 split and digitize portions of the UL signals for signal processor 1105. Filters 1102 remove unwanted energy from the UL signals per the filter instructions and transfer the filtered UL signals to phase shifters 1103. Phase-shifters 1103 delay the UL signals per the phase instructions and transfer the phase-shifted UL signals to amps 1103. Amps 1103 add power to the UL signals per the amp instructions and transfer the amplified UL signals to radiating elements 1101. Radiating elements 1101 convert the electrical/optical UL signals into a wireless uplink signal for 5GNR AN 502.

Contemporaneously with the uplink signal processing, 5GNR AN 502 wirelessly transfers a Downlink (DL) signal to radiating elements 1101. Radiating elements 1101 convert the wireless DL signal into electrical/optical DL signals and transfer the DL signals to filters 1102. Filters 1102 split and digitize portions of the DL signals for signal processor 1105. Filters 1102 remove unwanted energy from the DL signals per the filter instructions and transfer the filtered DL signals to phase shifters 1103. Phase-shifters 1103 delay the DL signals per the phase instructions and transfer the phase-shifted DL signals to amps 1103. Amps 1103 add power to the DL signals per the amp instructions and transfer the amplified DL signals to radiating elements 1101. Radiating elements 1101 convert the electrical/optical DL signals into a wireless DL signal for 5GNR AN 502.

Contemporaneously with the UL/DL signal processing, filters 1102 transfer the UL/DL signal information to signal processor 1105. Signal processor 1105 transfers the UL/DL signal information or a processing result to VARA controller 519 over radio 1106, 5GNR AN 502, and AMF 510. VARA controller 519 processes the UL/DL signal information to generate and transfer the filter control information, phase control information, and amp control information to signal processor 1105. The filter control information indicates the radio bands that should be passed by the filters. The phase control information points radio beams at desired targets—possibly based on the angle-of-arrival of signals from the targets. The amp control information boosts and steers the UL/DL signals to overcome path loss and point towards the target. Signal processor 1105 transfers filter instructions based on the filter control information to filters 1102. Signal processor 1105 transfers phase instructions based on the phase control information to phase-shifters 1103. Signal processor 1105 transfers amp instructions based on the amp control information to amps 1104.

UE 501 wirelessly transfers an UL signal to radiating elements 1101. Radiating elements 1101 convert the wireless UL signal into an electrical/optical UL signals and transfer the UL signals to filters 1102. Filters 1102 split and digitize portions of the UL signals for signal processor 1105. Filters 1102 remove unwanted energy from the UL signals per the filter instructions and transfer the filtered UL signals to phase shifters 1103. Phase-shifters 1103 delay the UL signals per the phase control information and transfer the phase-shifted UL signals to amps 1103. Amps 1103 add power to the UL signals per the amp control information and transfer the amplified UL signals to radiating elements 1101. Radiating elements 1101 convert the electrical/optical UL signals into a wireless uplink signal for 5GNR AN 502.

Contemporaneously with the UL signal processing, 5GNR AN 502 wirelessly transfers a DL signal to radiating elements 1101. Radiating elements 1101 convert the wireless DL signal into electrical/optical DL signals and transfer the DL signals to filters 1102. Filters 1102 split and digitize portions of the DL signals for signal processor 1105. Filters 1102 remove unwanted energy from the DL signals per the filter control information and transfer the filtered DL signals to phase shifters 1103. Phase-shifters 1103 delay the DL signals per the phase control information and transfer the phase-shifted DL signals to amps 1103. Amps 1103 add power to the DL signals per the amp control information and transfer the amplified DL signals to radiating elements 1101. Radiating elements 1101 convert the electrical/optical DL signals into a wireless DL signal for 5GNR AN 502.

Contemporaneously with the UL/DL signal processing, filters 1102 transfer the UL/DL signal information to signal processor 1105. Signal processor 1105 transfers the signal information or a subsequent processing result to VARA controller 519 over radio 1106, 5GNR AN 502, and AMF 510.

Advantageously, wireless communication network 500 uses harvested electrical power to efficiently reflect radio beams between wireless communication devices. Moreover, wireless communication network 500 effectively identifies radio targets and points the radio beams at the radio targets.

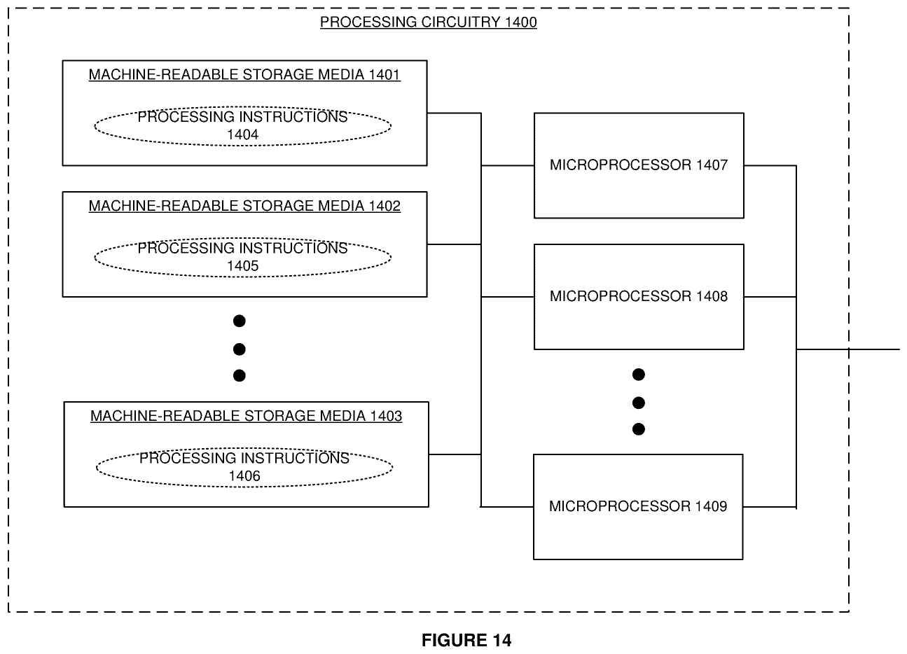

FIG. 14 illustrates exemplary processing circuitry 1400 to use a reflective array to transfer signals between wireless communication devices. Processing circuitry 1400 comprises an example of reflective arrays 110 and 400, NFVI 506, and VARAs 521-523, although these network elements may differ. Processing circuitry 1400 comprises machine-readable storage media 1401-1403 and microprocessors 1407-1409 that are communicatively coupled. Machine-readable storage media 1401-1403 store processing instructions 1404-1406 in a non-transitory manner. Microprocessors 1407-1409 comprise DSPs, CPUs, GPUs, ASICs, and/or some other data processing hardware. Machine-readable storage media 1401-1403 comprises RAM, flash circuitry, disk drives, and/or some other type of data storage apparatus. Microprocessors 1407-1409 retrieve processing instructions 1404-1406 from non-transitory machine-readable storage media 1401-1403. Microprocessors 1407-1409 execute processing instructions 1404-1406 to control power to radio capabilities as described above for data system 100, reflective array 400 and wireless communication network 500. The amount of storage media, microprocessors, processing instructions that are shown in FIG. 14 may vary in other examples.

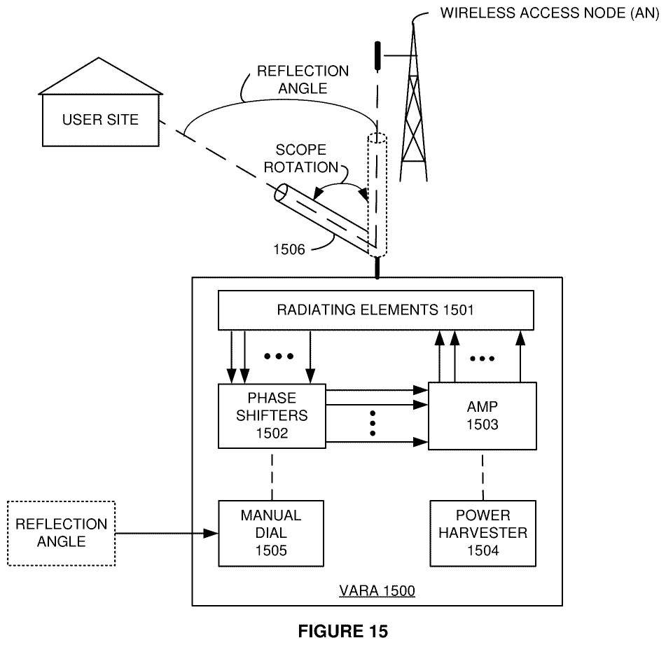

FIG. 15 illustrates exemplary VARA 1500 that uses a manual input to transfer signals between a user site and a wireless access AN. VARA 1500 comprises an example of reflective array 110, although array 110 may differ. VARA 1500 comprises radiating elements 1501, phase shifters 1502, amp 1503, power harvester 1504, manual dial 1505, and optical scope 1506. Optical scope 1506 is mounted on VARA 1500 and may be rotated to point at the wireless AN using line-of-sight. Optical scope 1506 is then rotated to point at the user site using line-of-sight, and the two lines-of-sight indicate the reflection angle. The reflection angle is then input using manual dial 1505 which physically adjusts the delays in phase shifters 1502 to reflect wireless signals between the wireless access node and the user site at that reflection angle. In some examples, radiating elements 1501 are installed to point at the wireless access node using optical scope 1506 and line-of-sight. Optical scope 1506 is then rotated to point at the user site and determine the reflection angle. Power harvester 1504 converts sunlight and/or RF waves into electrical energy for amp 1503. Amp 1503 uses the electrical energy to boost the power of the wireless signals that are transmitted from radiating elements 1501.

The wireless communication system circuitry described above comprises computer hardware and software that form special-purpose data communication circuitry to intelligently reflect wireless signals using harvested electrical power. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to intelligently reflect wireless signals using harvested electrical power.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
harvesting electrical power from one of solar radiation and terrestrial radio signals;
determining a geographic direction using the harvested electrical power;
wirelessly receiving a communication signal;
phase-shifting the communication signal for transmission toward the geographic direction; and
wirelessly transmitting the phase-shifted communication signal toward the geographic direction.

2. The method of claim 1 wherein phase-shifting the communication signal comprises using the electrical power to phase-shift the communication signal.

3. The method of claim 1 comprising:
amplifying the communication signal for transmission toward the geographic direction using the harvested electrical power; and wherein
wirelessly transmitting the phase-shifted communication signal toward the geographic direction comprises wirelessly transmitting the phase-shifted and amplified communication signal toward the geographic direction.

4. The method of claim 1 comprising:
filtering the communication signal using the harvested electrical power; and wherein
wirelessly transmitting the phase-shifted communication signal toward the geographic direction comprises wirelessly transmitting the filtered and phase-shifted communication signal toward the geographic direction.

5. The method of claim 1 wherein determining the geographic direction comprises:
receiving another communication signal from the geographic direction; and
determining the geographic direction based on the other communication signal.

6. The method of claim 1 wherein determining the geographic direction comprises:
receiving another communication signal from the geographic direction; and
determining the geographic direction based on an angle-of-arrival of the other communication signal.

7. The method of claim 1 wherein determining the geographic direction comprises receiving control information that indicates the geographic direction.

8. A reflective array comprising:
radiating elements to wirelessly receive downlink signals from a network direction;
the radiating elements to wirelessly receive uplink signals from a user direction;
a signal processor to determine the user direction, and in response, phase-shift the downlink signals for transmission in the user direction;
the radiating elements to wirelessly transmit the phase-shifted downlink signals in the user direction and wirelessly transmit the uplink signals in the network direction; and wherein
pairs of the radiating elements are coupled together through the signal processor and each one of the pairs are to exchange individual ones of the uplink signals and individual ones of the downlink signals through the signal processor.

9. The reflective array of claim 8 further comprising the signal processor to amplify the uplink signals and the downlink signals.

10. The reflective array of claim 8 further comprising:
the signal processor to determine the network direction, and in response, phase-shift the uplink signals for transmission in the network direction; and
the radiating elements to wirelessly transmit the phase-shifted uplink signals in the network direction.

11. The reflective array of claim 8 wherein the signal processor is to determine an angle-of-arrival for the uplink signals to determine the user direction.

12. The reflective array of claim 8 wherein the signal processor is to determine an angle-of-arrival for the downlink signals to determine the network direction.

13. The reflective array of claim 8 wherein:
the signal processor is to determine individual phase-shifts for each of the pairs of the radiating elements; and
the signal processor is to phase-shift the downlink signals based on the individual phase-shifts for each the pairs of the radiating elements.

14. The reflective array of claim 8 wherein:
the signal processor is to determine individual power-levels for each of the pairs of the radiating elements; and
the signal processor is to amplify the downlink signals based on the individual power-levels for each of the pairs of the radiating elements.

15. The reflective array of claim 8 wherein:
the signal processor is to receive control information that indicates individual phase-shifts for each of the pairs of the radiating elements; and
the signal processor is to phase-shift the downlink signals based on the control information.

16. The reflective array of claim 8 wherein:
the signal processor is to receive control information that indicates individual power-levels for each of the pairs of the radiating elements; and
the signal processor is to amplify the downlink signals based on the control information.

17. The reflective array of claim 8 wherein:
the signal processor is to receive control information that indicates individual phase-shifts and individual power-levels for each of the pairs of the radiating elements; and
the signal processor is to phase-shift and amplify the uplink signals based on the control information.

18. A Van Atta Reflective Array (VARA) comprising:
at least one of a solar power harvester and a Radio Frequency (RF) power harvester to generate electrical power;
VARA elements to wirelessly receive first signals and second signals;
a VARA processor to consume the electrical power and phase-shift the second signals based on the first signals; and
the VARA elements to wirelessly transmit the first signals and the phase-shifted second signals.

19. The VARA of claim 18 further comprising the VARA processor to determine an angle-of-arrival for the first signals and phase-shift the second signals based on the angle-of-arrival for the first signals.

20. The VARA of claim 18 further comprising the VARA processor to amplify the first signals and the second signals.
